(19) United States
(12) Patent Application Publication
(10) Pub. No.: US 2024/0399903 A1
(43) Pub. Date: Dec. 5, 2024

(54) CABLE MANAGEMENT DEVICE AND METHOD FOR CHARGING STATIONS FOR VEHICLES

(71) Applicant: Siemens Aktiengesellschaft, Munchen (DE)

(72) Inventors: Albert Völkl, München (DE); Stefan Perras, Eichenau (DE)

(21) Appl. No.: 18/731,607

(22) Filed: Jun. 3, 2024

(30) Foreign Application Priority Data
Jun. 2, 2023 (DE) 10 2023 205 169.9

(51) Int. Cl. B60L 53/18; H02G 11/00

(52) U.S. Cl. CPC B60L 53/18; H02G 11/003

(57) ABSTRACT

A device for providing a vehicle charging cable includes a carrier structure to be fastened at a distance from the ground, and a charging cable be connected to an electricity source and having a charging plug for plugging into a vehicle to be charged. A first cable pull device fastened to the carrier structure has a first carrier cable fastened between a first suspension point of the charging cable and the carrier structure. A second cable pull device fastened to the carrier structure at a distance from the first cable pull device has a second carrier cable fastened between the carrier structure and a second suspension point of the charging cable remote from the first suspension point. The first and second cable pull devices independently set lengths of the first and second carrier cables, permitting distances of the first and second suspension points from the ground to be set.

### CROSS-REFERENCE TO RELATED APPLICATION

This application claims the priority, under 35 U.S.C. § 119, of German Patent Application DE 10 2023 205 169.9, filed Jun. 2, 2023; the prior application is herewith incorporated by reference in its entirety.

### FIELD AND BACKGROUND OF THE INVENTION

The present invention relates to a device and a method for providing a charging cable for a vehicle.

In addition to the electrification of smaller vehicles, such as passenger cars, for example, it is also possible to electrify utility vehicles, such as trucks, for example. The operation of utility vehicles is highly cost-driven, which is why, when they are electrified, additional downtimes caused by charging breaks for the high voltage battery have to be avoided. For that reason, it is advantageous to construct charging infrastructure for example at the loading and unloading sites of trucks. Since there is often little space for maneuvering in truck and bus depots, it is difficult to arrange charging columns or charge distributors (dispensers) in such a way that they impede the operation of the depot as little as possible. There is also a risk of charging columns or dispensers being damaged by maneuvering operations and thus a risk of these charging points being put out of operation.

One possible way of reducing the risk of damage is to fit the dispenser at a sufficient distance above the roadway. However, in that case, the cable management of the charging cables represents a particular challenge, since the charging plug of the charging cable or the charging cable itself must not be damaged by maneuvering trucks.

### SUMMARY OF THE INVENTION

It is accordingly an object of the invention to provide a cable management device and a method for charging stations for vehicles, which overcome the hereinafore-mentioned disadvantages of the heretofore-known devices and methods of this general type.

The object is achieved by a device and a method for providing a charging cable for a vehicle according to the subject matter of the independent claims.

According to a first aspect of the present invention, a device for providing a charging cable for a vehicle is described. The device has a carrier structure which is able to be fastened at a distance from the ground, and a charging cable which is able to be connected to an electricity source (for example via a charge distributor) and has a charging plug for plugging into a vehicle to be charged. The charging cable is fastened to the carrier structure.

The device has, in particular, a first cable pull device fastened to the carrier structure. The first cable pull device has a first carrier cable which is fastened between a first suspension point of the charging cable and the carrier structure. Furthermore, the device has a second cable pull device which is fastened to the carrier structure at a distance from the first cable pull device. The second cable pull device has a second carrier cable which is fastened between a second suspension point of the charging cable, which is formed at a distance from the first suspension point, and the carrier structure. The first cable pull device and the second cable pull device are each formed in such a way that the lengths of the first carrier cable and of the second carrier cable are settable independently of one another in such a way that a distance of the first suspension point and of the second suspension point from the ground is settable.

According to a further aspect, a device for providing a charging cable for a vehicle by way of an abovementioned device is described. According to the method, the lengths of the first carrier cable and of the second carrier cable are set independently of one another in order to set a distance of the first suspension point and of the second suspension point from the ground.

The vehicle may represent an electrically driven vehicle, for example a purely electrically driven vehicle or a hybrid vehicle, which has a rechargeable battery. The vehicle has in particular a charging socket into which the charging plug of the charging cable is pluggable. The vehicle is for example an electrically driven passenger car or a utility vehicle, for example a truck, a bus, a construction machine or an agricultural machine.

The carrier structure serves for fastening the device components to a building or to the ground. The carrier structure carries in particular the cable pull device and the charging cable. The charging cable is in particular connected or able to be connected to an electricity source. For example, electric charging components, such as a charge distributor (dispenser), can be fastened to the carrier structure in such a way that current is transferable from the charge distributor to the charging cable.

The first cable pull device is fastened to the carrier structure. The first cable pull device has the first carrier cable, which fastens the charging cable to the first suspension point. In other words, the charging cable hangs down from the carrier structure by way of the carrier cable. The first carrier cable may be fastened for example reversibly or irreversibly to the charging cable at the first suspension point. In a corresponding manner, the second cable pull device is fastened, reversibly or irreversibly, to the charging cable at the second suspension point by way of the second carrier cable, in such a way that the charging cable is suspended from the carrier structure by way of the second carrier cable. The suspension points define the portion or point at which the corresponding carrier cables are fastened to the charging cable.

According to the present invention, the carrier cables are fastened to the carrier structure at a distance from one another and hold corresponding portions of the charging cable at suspension points that are spaced apart from one another. Each of the carrier cables can individually set the distance between the corresponding suspension point and the carrier structure, with the result that the suspension points adopt a settable height above the ground. In the case of an arrangement with two cable pull devices, the charging cable first of all extends from a coupling point on the carrier structure to the first cable pull device, or to a coupling at the first suspension point. From there, the charging cable extends to the second cable pull device, or to the second suspension point on the second carrier cable. From the second suspension point, the charging cable extends onward as far as its end, at which the charging plug is disposed. In further exemplary embodiments, as described below, further cable pull devices with further suspension points can be provided after the second suspension point.

The carrier cables may be produced for example from wire, plastic or from natural materials, such as hemp, for example. Furthermore, in the scope of the present invention, a chain, for example made of metal, or a band or belt may likewise represent a carrier cable.

As a result of the cable lengths of the carrier cables being set, the ground clearance between the suspension points and the ground is individually set. Thus, in an inactive state, in which no vehicle is positioned at the device, the suspension points can be set in the direction of the carrier structure in such a way that the charging cable is in the vicinity of the carrier structure at a distance from the ground. Once a vehicle has been maneuvered in particular under the carrier structure and is positioned in a predetermined position or charging position relative to the carrier structure, the cable lengths of the carrier cables can be increased specifically in such a way that a user can take hold of the charging plug and can plug it into the charging socket of the vehicle.

As a result of the charging cable being mounted flexibly at two spaced-apart cable pull devices or suspension points above the ground, the charging plug can be positioned in the vicinity of the charging socket of the vehicle without the weight force of the cable having to be borne by the user. Besides the exactly settable height, a horizontal position, i.e. a position between the coupling point, the first suspension point and the second suspension point can furthermore be set very flexibly at a predefined height. The cable pull devices can also be disposed vertically above the coupling point in such a way that, with the aid of the cable pulls, the charging plug also reaches positions beyond the coupling point. In the case of a charging cable that is simply hanging down, horizontal adjustment of the coupling point between the charging plug and the charging socket is difficult since the charging cable has a significant weight and the user has to carry or pull the charging cable themself. Due to the horizontally spaced-apart suspension points of the cable pull devices, the height of which can also be set, flexibility in the horizontal direction can thus be enabled. Exact positioning of the vehicle at an exactly predetermined position relative to the device is thus not necessary, since a flexible way of setting the position of the charging plug is also possible horizontally.

According to a further exemplary embodiment, the charging cable is configured in such a way that the charging cable extends from a coupling point with the carrier structure to the first suspension point and then onward to the second suspension point, wherein the charging cable is disposed on the carrier structure, the first cable pull device and the second cable pull device in such a way that, along a horizontal direction component, the coupling point is located between the first suspension point and the second suspension point.

In other words, the charging cable initially hangs down from the carrier structure from the coupling point. Subsequently, the charging cable extends to the first suspension point, forms a loop and extends in the opposite direction to the second suspension point. The region of the charging cable between the coupling point and the second suspension point thus forms a C-shaped course. The region of the loop at the first suspension point can be adjusted flexibly in the direction of the ground. In a corresponding manner, the region at the charging plug or at the second suspension point can also be adjusted flexibly in the direction of the ground. The shape of the cable course of the charging cable can be set depending on how the length ratios between the first carrier cable and the second carrier cable are formed. Since the carrier cables are disposed in an immovable manner, i.e. so as not to be movable along the charging cable, a different setting of the cable lengths of the carrier cables not only changes a vertical position of the suspension points above the ground but also changes a horizontal position of the suspension points and accordingly of the charging plug. With the described exemplary embodiment, it is thus possible, in addition to a vertical position, for a horizontal position of the charging plug to likewise be set without the user having to use significant muscular strength and without the vehicle needing to be positioned exactly at a predetermined position for charging.

According to a further exemplary embodiment, the carrier structure has a crossbeam on which the first cable pull device and the second cable pull device are disposed. In a first alternative, the crossbeam may be able to be fastened at a distance from the ground at least on one side by using a ground support. Alternatively, the crossbeam may be able to be fastened to a ceiling construction, in particular to a ceiling of a building.

In the first alternative, the carrier structure forms an independent structure, in the case of which the crossbeam is fastened to the ground by way of the ground support, for example made of a steel construction or of concrete. In particular, the ground support can be disposed at one end of the crossbeam. The ground support or the crossbeam may be produced for example from a solid material (for example a T-beam) or form a truss. Furthermore, a further ground support may be disposed at an opposite end of the crossbeam, in such a way that a corresponding ground support is provided at both ends of the crossbeam.

According to a further exemplary embodiment, the carrier structure has a boom on which the first cable pull device and/or the second cable pull device is/are disposed. The boom is fastened to the crossbeam and projects laterally with respect to the extension direction of the crossbeam. For example, charging components, such as a charge distributor (dispenser) for example, may be disposed on the crossbeam, wherein the cable pull devices are fastened to the boom at a distance from one another. The boom may be formed for example of a solid material or represent a truss.

In particular, the boom may be at a right angle or form an angle of 90° between the extension direction of the boom and the extension direction of the crossbeam. The vehicle may enter the device for example in a predetermined entry direction. The crossbeam extends for example transversely to the entry direction, in such a way that the vehicle can be positioned under the crossbeam. The boom, which extends in particular at a right angle from the crossbeam, thus extends parallel to the entry direction and thus along a side face of the positioned vehicle. The cable pull devices disposed at a distance from one another on the boom thus extend along the side face of the positioned vehicle. Through the use of the setting of the lengths of the corresponding carrier cables, it is thus possible for the position of the charging plug along the side faces of the vehicle to be set.

According to a further exemplary embodiment, the boom is able to be fastened pivotably to the crossbeam. Thus, it is possible for example for a position of the cable pull devices fastened to the boom to be adjusted transversely to the entry direction. For example, it is also possible for the boom to be pivoted in in an inactive state, in such a way that it extends parallel to the crossbeam, and for the boom to be pivoted out in an active state, in such a way that it extends at a right angle to the crossbeam.

According to a further exemplary embodiment, the boom is disposed so as to be movable in the extension direction of the crossbeam. Alternatively, the boom can be moved along the crossbeam via guide rails. Thus, it is possible, for example, for a different width of the vehicles to be charged to be taken into account, in such a way that the charging cable can be hung down exactly along the side faces.

According to a further exemplary embodiment, the boom has, between two boom ends, a reinforcement beam which protrudes from the boom (substantially perpendicularly upward, in the opposite direction to the ground), wherein at least one tensioned reinforcement cable connects the boom ends and the reinforcement beam in order to stabilize the boom. Thus, bending moments which are induced in the boom by the weight force of the charging cable and the disposed cable pull devices are reduced or compensated by the reinforcement cables and the reinforcement beam.

According to a further exemplary embodiment, the first cable pull device and/or the second cable pull device has/have a cable winch. The cable winch is in particular a driven cable winch which can wind up and unwind the corresponding carrier cable. The corresponding cable winch of the first cable pull device and the cable winch of the second cable pull device can be coupled for example to a common control unit. The control unit can transmit corresponding control signals to the cable winches in order to control the latter and accordingly to set the cable lengths of the carrier cables. In this case, the control unit can be controlled centrally by a control center at a distance from the device, or, as described in one exemplary embodiment, be controlled by the user.

According to a further exemplary embodiment, the cable winch is an electric cable winch for setting the length of the corresponding carrier cable. The cable winch has for example an electric drive motor, which drives the cable winch as appropriate.

According to a further exemplary embodiment, an operating element for controlling the electric cable winch is disposed in the charging cable, in particular on the charging plug, wherein the operating element is coupled to the cable winch or the cable winches, in particular wirelessly or by wire, for the exchange of control data. In the embodiment connected by wire, a signal cable can be guided along the charging cable from the operating element as far as the dispenser or as far as the cable winch. The user can thus control the corresponding position of the charging plug directly at the charging plug via the controlling of the cable winches and accordingly control the lengths of the carrier cables without the user having to apply pulling forces to the charging cable.

According to a further exemplary embodiment, to set the length of the corresponding carrier cable, the cable winch has a spring-based retraction device with a return spring, in particular a spiral spring, which is configured in such a way that, when the corresponding carrier cable is extended out of the cable winch, a pretension is able to be generated in the return spring. The user can thus pull the charging cable into the desired position and couple the charging plug into the charging socket of the vehicle. Once the charging process is complete, the spring-based pretension force means that the carrier cables can be wound up by using the corresponding spring-based retraction device for example with little force on the part of the user. In addition, the spring-based retraction device may have a latching mechanism which, when extension of the corresponding carrier cable is complete, locks the cable winch so as to prevent winding up due to the spring force. When the user pulls briefly on the corresponding carrier cable again, this disengages the latch and so the carrier cable is wound up by using the spring-based retraction device. Thus, it is possible to control the cable winches and the lengths of the carrier cables without an electrical energy supply being required for the cable winches.

According to a further exemplary embodiment, the cable winch is disposed on the carrier structure or at the corresponding suspension point. If the cable winch is disposed on the carrier structure, the cable winch is in a fixed position and the suspension point on the corresponding carrier cable is adjusted or is moved relative to the cable winch. If the cable winch is disposed at the suspension point itself, the carrier cable can be fixed to the carrier structure and the cable winch is moved relative to the carrier structure and travels together with the suspension point in the direction of the ground.

According to a further exemplary embodiment, a handling cable is fastened to the charging cable, the handling cable being disposed in such a way that the charging cable is able to be reached by a user by using the handling cable. The handling cable may be fastened in particular in the vicinity of or at the second suspension point, or at the suspension point which is positioned closest to the charging plug. The handling cable is constructed to be lightweight and flexible so that a vehicle traveling through is not damaged. If the carrier cables are set to be short and the charging cable is accordingly positioned at a distance from the ground, the user can still take hold of the end of the handling cable and can pull the charging cable toward themself until they can take hold of the latter.

With the device according to the invention, it is accordingly also possible for a multiplicity of cable pull devices to be provided. Accordingly, in a further exemplary embodiment, the device may have a third cable pull device which is fastened to the carrier structure at a distance from the first cable pull device and from the second cable pull device. The third cable pull device has a third carrier cable which is fastened between a third suspension point of the charging cable, which is formed at a distance from the first suspension point and the second suspension point, and the carrier structure. The third cable pull device is formed in such a way that the length of the third carrier cable is settable.

In particular, in this case, the charging cable can extend from the coupling point to the first suspension point, onward to the second suspension point and finally to the third suspension point. The coupling point is disposed between the first suspension point and the second suspension point. In particular, the third cable pull device is disposed in such a way that the coupling point is likewise located between the second and the third suspension point. In other words, the charging cable initially hangs down from the carrier structure from the coupling point. Subsequently, the charging cable extends to the first suspension point, forms a loop and extends in the opposite direction to the second suspension point. There, the charging cable again forms a loop and extends to the third suspension point. The region of the charging cable between the coupling point and the third suspension point thus forms an S-shaped course. Due to the length setting of three or more carrier cables, the flexibility or the possible ways of setting the position of the charging plug can be increased. As a result of the additional cable pull devices, the sagging of the charging cable can be reduced. As a result, it is also possible for the length of the crossbeam or of the boom on which the cable pull devices are disposed to be shortened, since the charging cable can thus be folded multiple times.

According to a further exemplary embodiment, it is furthermore possible for further cable pull devices which carry a further charging cable to be disposed on the carrier structure, in order to charge a plurality of vehicles. Accordingly, such a device has a further charging cable which is able to be connected to an electricity source, and a further charging plug for plugging into a further vehicle to be charged, wherein the further charging cable is fastened to the carrier structure. Furthermore, the device has a further first cable pull device which is fastened to the carrier structure, wherein the further first cable pull device has a further first carrier cable which is fastened between a further first suspension point of the further charging cable and the carrier structure. Furthermore, the device has a further second cable pull device which is fastened to the carrier structure at a distance from the further first cable pull device, wherein the further second cable pull device has a further second carrier cable which is fastened between a further second suspension point of the further charging cable, which is formed at a distance from the further first suspension point, and the carrier structure. The further first cable pull device and the further second cable pull device are each formed in such a way that the lengths of the further first carrier cable and of the further second carrier cable are settable independently of one another in such a way that a distance of the further first suspension point and of the further second suspension point from the ground is settable.

If the carrier structure has a crossbeam, the first and second cable pull devices are disposed along the crossbeam at a distance from the further first and second cable pull devices. Thus, it is possible for example for two vehicles to be positioned next to one another under the crossbeam and for the one vehicle to be charged with the charging cable and the other vehicle to be charged with the further charging cable.

For example, a further boom can be positioned on the crossbeam, which is disposed at a distance from the other boom. The further boom can accordingly have the further first cable pull device and the further second cable pull device.

Accordingly, in a further exemplary embodiment, a multiplicity of separate first and second cable pull devices can be disposed and thus a corresponding multiplicity of vehicles to be charged can be positioned.

All the charging cables can be coupled for example to a common charge distributor (dispenser) which is fastened to the carrier structure.

In summary, the invention describes a cable management device formed of two or more cable pull devices which ensure that the unused cable portion of the charging cable is suspended at a safe distance from the roadway or the ground. If more is required, it can either be pulled down mechanically or be let down (for example electrically) with the aid of a controlled cable pull.

The device according to the invention is, due to the few moving parts, robust and can be produced easily and cost-effectively. As a result of the charging cable being folded once or multiple times, it can have a long cable length in such a way that a charging capability for a high variance of vehicles and different vehicle lengths can be used. At the same time, the cable does not impede any maneuvering vehicles.

It should be noted that the embodiments described herein represent only a limited selection of possible embodiment variants of the invention. Thus, it is possible to combine the features of individual embodiments suitably with one another in such a way that a multiplicity of different embodiments should be considered to be disclosed to a person skilled in the art with the embodiment variants that are explicit herein. Irrespective of the grammatical gender of a specific term, persons with male, female, or other gender identity are also included.

Other features which are considered as characteristic for the invention are set forth in the appended claims.

Although the invention is illustrated and described herein as embodied in a cable management device and method for charging stations for vehicles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a device having two cable pull devices, wherein a charging plug is coupled in a charging socket of a vehicle, according to one exemplary embodiment of the present invention;

FIG. 2 is a diagrammatic, perspective view of the device of FIG. 1, wherein the charging cable is kept at a distance from the ground, according to one exemplary embodiment of the present invention;

FIG. 3 is a diagrammatic, elevational view of a device having a carrier structure which is fastened to a ceiling, according to one exemplary embodiment of the present invention;

FIG. 4 is a diagrammatic, elevational view of a device having three cable pull devices according to one exemplary embodiment of the present invention; and

FIG. 5 is a diagrammatic, perspective view of a device having four cable pull devices, wherein a respective charging plugs is coupled in a charging socket of a respective vehicle, according to one exemplary embodiment of the present invention;

### DETAILED DESCRIPTION OF THE INVENTION

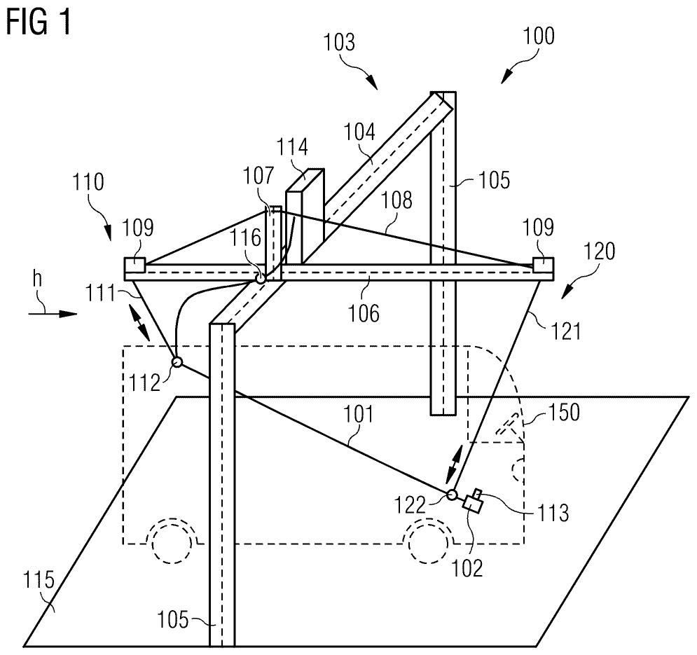

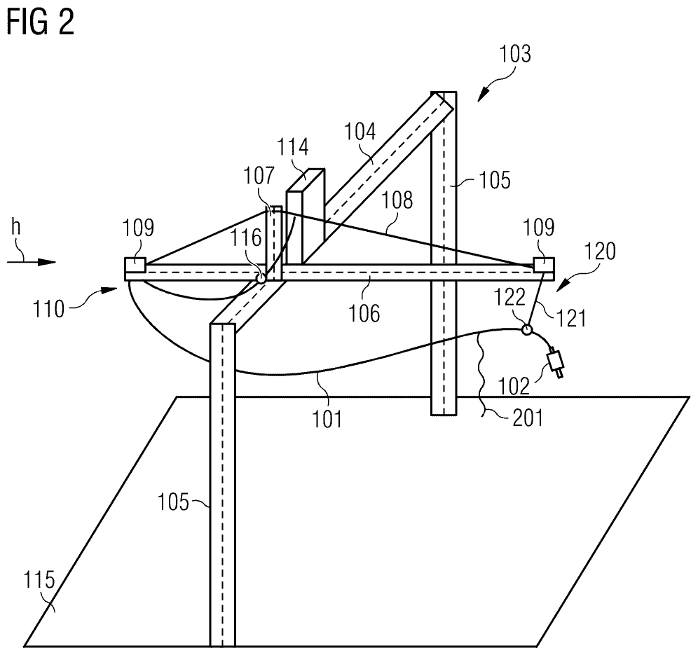

Referring now in detail to the figures of the drawings, which are diagrammatic and not to scale and in which identical or similar components are provided with the same reference signs, and first, particularly, to FIG. 1 thereof, there is seen a device 100 having two cable pull devices 110, 120, wherein a charging plug 102 is coupled in a charging socket of a vehicle 150. FIG. 2 shows the device 100 from FIG. 1, wherein a charging cable 101 is kept at a distance from the ground 115.

The device 100 has a carrier structure 103 which is able to be fastened at a distance from the ground 115, the charging cable 101 which is able to be connected to an electricity source, and the charging plug 102 for plugging into the vehicle 150 to be charged. The device 100 has the first cable pull device 110 which is fastened to the carrier structure 103, wherein the first cable pull device 110 has a first carrier cable 111 which is fastened between a first suspension point 112 of the charging cable 101 and the carrier structure 103. The device 100 also has the second cable pull device 120 which is fastened to the carrier structure 103 at a distance from the first cable pull device 110, wherein the second cable pull device 120 has a second carrier cable 121 which is fastened between a second suspension point 122 of the charging cable 101, which is formed at a distance from the first suspension point 112, and the carrier structure 103. The first cable pull device 110 and the second cable pull device 120 are each formed in such a way that the lengths of the first carrier cable 111 and of the second carrier cable 121 are settable independently of one another in such a way that a distance of the first suspension point 112 and of the second suspension point 122 from the ground 115 is settable.

The carrier structure 103 serves for fastening the device components to the ground 115. The carrier structure 103 has a crossbeam 104 on which the first cable pull device 110 and the second cable pull device 120 are disposed. In the illustrated embodiment, the crossbeam is fastened to the ground 115 by two ground supports 105, for example made of a steel construction or of concrete, in such a way that a corresponding ground support 105 is provided at both ends of the crossbeam 104.

The carrier structure 103 has a boom 106 on which the first cable pull device 110 and the second cable pull device 120 are disposed. The boom 106 is fastened to the crossbeam 104 and projects laterally with respect to the extension direction of the crossbeam 104. For example, charging components, such as a charge distributor (dispenser) 114 for example, may be disposed on the crossbeam 104, wherein the cable pull devices 110, 120 are fastened to the boom 106 at a distance from one another. The boom 106 may be formed for example of a solid material or may represent a truss.

In particular, the boom 106 is formed at a right angle to the extension direction of the crossbeam 104. The vehicle 150 may enter the device 100 for example in a predetermined entry direction. The crossbeam 104 extends for example transversely to the entry direction, in such a way that the vehicle 150 can be positioned under the crossbeam 104. The boom 106, which extends in particular at a right angle from the crossbeam 104, thus extends parallel to the entry direction and thus along a side face of the positioned vehicle 150. The cable pull devices 110, 120 disposed at a distance from one another on the boom 106 thus extend along the side face of the positioned vehicle 115. Through the use of the setting of the lengths of the corresponding carrier cables 111, 112, it is thus possible for the position of the charging plug 102 along the side faces of the vehicle 150 to be set.

The first cable pull device 110 has the first carrier cable 111, which fastens the charging cable 101 to the first suspension point 112. In other words, the charging cable 101 hangs down from the boom 106 by way of the carrier cable 111. The first carrier cable 111 may be fastened for example reversibly or irreversibly to the charging cable 101 at the first suspension point 112. In a corresponding manner, the second cable pull device 120 is fastened, reversibly or irreversibly, to the charging cable 101 at the second suspension point 122 by way of the second carrier cable 121, in such a way that the charging cable 101 is suspended from the boom 106 by way of the second carrier cable 121.

Each of the carrier cables 111, 121 can individually set the distance between the corresponding suspension point 112, 122 and the carrier structure 103. In the case of an arrangement with two cable pull devices 110, 120, the charging cable 101 first of all extends from a coupling point 116 on the carrier structure 103, always for example on the crossbeam 104 or the beam 106, to the first cable pull device 110, or to a coupling at the first suspension point 112. From there, the charging cable 101 extends to the second cable pull device 120, or to the second suspension point 122 on the second carrier cable 121. From the second suspension point 122, the charging cable 101 extends onward as far as its end, at which the charging plug 102 is disposed.

As a result of the cable lengths of the carrier cables 111, 121 being set, the ground clearance between the suspension points 112, 122 and the ground 115 is individually set. Thus, in an inactive state, in which no vehicle 150 is positioned at the device 110 (see FIG. 2), the suspension points 112, 122 can be set in the direction of the carrier structure 103 in such a way that the charging cable 101 is in the vicinity of the carrier structure 103 at a distance from the ground. Once a vehicle 115 has been maneuvered in particular under the crossbeam 104 and is positioned in a predetermined position or charging position relative to the carrier structure 103, the cable lengths of the carrier cables 111, 121 can be increased specifically in such a way that a user can take hold of the charging plug 102 and can plug it into the charging socket of the vehicle 115.

The charging cable 101 is configured in such a way that the charging cable 101 extends from the coupling point 116 to the first suspension point 112 and then onward to the second suspension point 122, wherein the charging cable 101 is disposed on the carrier structure 103, the first cable pull device 110 and the second cable pull device 120 in such a way that, along a horizontal direction component h, the coupling point 116 is located between the first suspension point 112 and the second suspension point 122. The charging cable 101 initially hangs down from the carrier structure 103 from the coupling point 116. Subsequently, the charging cable 101 extends to the first suspension point 112, forms a loop and extends in the opposite direction to the second suspension point 122. The region of the charging cable 101 between the coupling point 116 and the second suspension point 122 thus forms a C-shaped course. The region of the loop at the first suspension point 112 can be adjusted flexibly in the direction of the ground 115. In a corresponding manner, the region at the charging plug 102 or at the second suspension point 122 can also be adjusted flexibly in the direction of the ground 115. The shape of the cable course of the charging cable 101 can be set depending on how the length ratios between the first carrier cable 111 and the second carrier cable 112 are formed.

The boom 106 may be able to be fastened for example pivotably to the crossbeam 104. Thus, it is possible for example for a position of the cable pull devices 110, 120 fastened to the boom 106 to be adjusted transversely to the entry direction.

The boom 106 has, between two boom ends, a reinforcement beam 107 which protrudes from the boom 106 perpendicularly upward, in the opposite direction to the ground 115. A tensioned reinforcement cable 108 connects the boom ends and the reinforcement beam 107 in order to stabilize the boom 106.

The first cable pull device 110 and the second cable pull device 120 each have a cable winch 109. The cable winch 109 is in particular a driven cable winch which can wind up and unwind the corresponding carrier cable 111, 121. The corresponding cable winch 109 of the first cable pull device 110 and the cable winch 109 of the second cable pull device 120 can be coupled for example to a common control unit. The control unit can transmit corresponding control signals to the cable winches 109 in order to control the latter and accordingly to set the cable lengths of the carrier cables 111, 121. The cable winches 109 can form electric cable winches with an electric drive motor. An operating element 113 for controlling the electric cable winch 109 is disposed in the charging cable 101, in particular on the charging plug 102, wherein the operating element 113 is coupled to the cable winch 109, in particular wirelessly, for the exchange of control data. The user can thus control the corresponding position of the charging plug 102 directly at the charging plug 102 via the controlling of the cable winches and accordingly control the lengths of the carrier cables 111, 121 without the user having to apply pulling forces to the charging cable 101.

Furthermore, the cable winch 109 may be mechanically controllable by a spring-based retraction device having a return spring, in particular a spiral spring, which is configured in such a way that, when the corresponding carrier cable 111, 121 is extended out of the cable winch 109, a pretension is able to be generated in the return spring. Furthermore, a handling cable 201 is fastened to the charging cable 101, the handling cable being disposed in such a way that the charging cable 101 is able to be reached by a user by using the handling cable 202, in particular in the position at a distance from the ground 115 as illustrated in FIG. 2. The handling cable 201 may be positioned in particular in the vicinity of the charging plug. If the carrier cables 111, 121 are set to be short, as illustrated in FIG. 2, and the charging cable 101 is accordingly positioned at a distance from the ground 115, the user can still take hold of the end of the handling cable 201 and can pull the charging cable 101 toward themself or herself until they can take hold of the latter.

The cable winches 109 are fastened to the boom 106 in a fixed position on the latter. Alternatively, the cable winches 109 can be disposed at the corresponding suspension points 112, 122 and move relative to the boom 106.

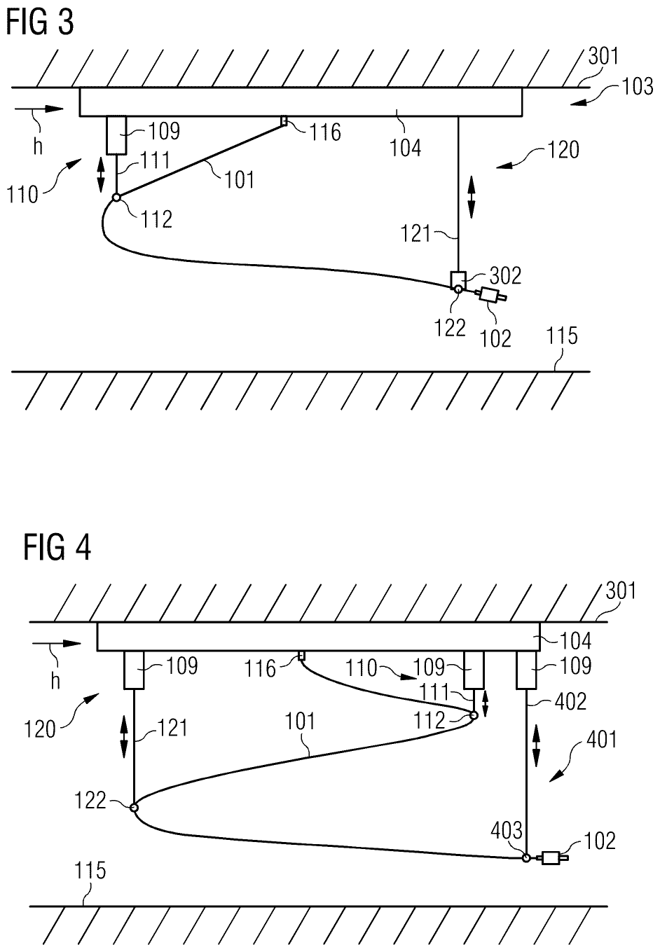

FIG. 3 shows a diagrammatic illustration of a device 100 having a carrier structure 103 which is fastened to a ceiling structure 301, for example to a ceiling of a building.

Also illustrated in FIG. 3 is a cable winch 302 of the second cable pull device 120, which is disposed at the second suspension point 122 itself. The carrier cable 121 is secured to the crossbeam 104 and the cable winch 302 moves relative to the crossbeam 104 and travels together with the suspension point 122 in the direction of the ground 115.

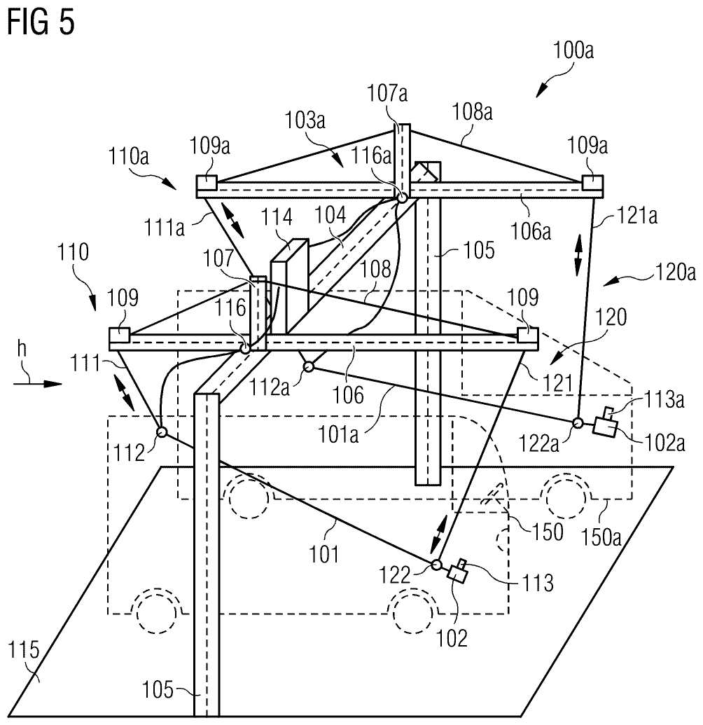

FIG. 4 shows a diagrammatic illustration of a device having three cable pull devices 110, 120, 401. In a similar fashion to the embodiment of FIG. 1, the device 100 has a carrier structure 103 which is able to be fastened at a distance from the ground 115, a charging cable 101 which is able to be connected to an electricity source and has a charging plug 102 for plugging into a vehicle 150 to be charged. The device 100 has a first cable pull device 110 which is fastened to the carrier structure 103, wherein the first cable pull device 110 has a first carrier cable 111 which is fastened between a first suspension point 112 of the charging cable 101 and the carrier structure 103. The device 100 also has a second cable pull device 120 which is fastened to the carrier structure 103 at a distance from the first cable pull device 110, wherein the second cable pull device 120 has a second carrier cable 121 which is fastened between a second suspension point 122 of the charging cable 101, which is formed at a distance from the first suspension point 112, and the carrier structure 103. The first cable pull device 110 and the second cable pull device 120 are each formed in such a way that the lengths of the first carrier cable 111 and of the second carrier cable 121 are settable independently of one another in such a way that a distance of the first suspension point 112 and of the second suspension point 122 from the ground 115 is settable.

In addition, the device 100 has the third cable pull device 401, which is fastened to the carrier structure 103, or to the crossbeam 104, at a distance from the first cable pull device 110 and from the second cable pull device 120. The third cable pull device 401 has a third carrier cable 402 which is fastened between a third suspension point 403 of the charging cable 101, which is formed at a distance from the first suspension point 112 and the second suspension point 122, and the carrier structure 103. The third cable pull device 401 is formed in such a way that the length of the third carrier cable 402 is settable.

In particular, in this case, the charging cable 101 extends from the coupling point 116 to the first suspension point 112, onward to the second suspension point 122 and finally to the third suspension point 403. The coupling point 116 is disposed between the first suspension point 112 and the second suspension point 122. In particular, the third cable pull device 401 is disposed in such a way that the coupling point 116 is likewise located between the second and the third suspension points 122, 403. In other words, the charging cable 101 initially hangs down from the carrier structure from the coupling point 116. Subsequently, the charging cable 101 extends to the first suspension point 112, forms a loop and extends in the opposite direction to the second suspension point 122. There, the charging cable 101 again forms a loop and extends to the third suspension point 403. The region of the charging cable 101 between the coupling point 116 and the third suspension point 403 thus forms an S-shaped course. Due to the length setting of the three carrier cables 111, 121, 402, the flexibility or the possible ways of setting the position of the charging plug 102 can be increased.

According to another embodiment illustrated in FIG. 5 the device 100a has a further charging cable 101a which is able to be connected to an electricity source. In the following only the difference to the device 100 of FIG. 1 will be described.

The further charging cable 101a is fastened to the carrier structure 103a and has a further charging plug 102a for plugging into a further vehicle 150a to be charged. The further charging cable 101a has a further first and a further second suspension points 112a, 122a disposed at a distance from one another.

A further first cable pull device 110a is fastened to the carrier structure 103a. The further first cable pull device 110a has a further first carrier cable 111a fastened between the further first suspension point 112a and the carrier structure 103a.

A further second cable pull device 120a is fastened to the carrier structure 103a at a distance from the further first cable pull device 110a. The further second cable pull device 120a has a further second carrier cable 121a fastened reversibly or irreversibly between the further second suspension point 122a and the carrier structure 103a.

The further first cable pull device 110a and the further second cable pull device 120a independently set lengths of the further first carrier cable 111a and the further second carrier cable 121a, permitting distances from the further first suspension point 112a and from the further second suspension point 122a to the ground 115 to be set.

The carrier structure 103a has a further boom 106a on which the further first cable pull device 110a and the further second cable pull device 120a are disposed. The further boom 106a is fastened to the crossbeam 104 and projects laterally with respect to the extension direction of the crossbeam 104. For example, charging components, such as a charge distributor (dispenser) 114 for example, may be disposed on the crossbeam 104, wherein the further cable pull devices 110a, 120a are fastened to the further boom 106a at a distance from one another. The further boom 106a may be formed for example of a solid material or may represent a truss.

The further boom 106a has, between two boom ends, a (further) reinforcement beam 107a which protrudes from the further boom 106a perpendicularly upward, in the opposite direction to the ground 115. A further tensioned reinforcement cable 108a connects the boom ends and the further reinforcement beam 107a in order to stabilize the further boom 106a.

In particular, the further boom 106a is formed at a right angle to the extension direction of the crossbeam 104. The further vehicle 150a may enter the device 100a for example in a predetermined entry direction. The further cable pull devices 110a, 120a disposed at a distance from one another on the further boom 106a thus extend along the side face of the positioned vehicle 150a. Through the use of the setting of the lengths of the corresponding further carrier cables 111a, 112a, it is thus possible for the position of the further charging plug 102a along the side faces of the further vehicle 150a to be set.

The further first carrier cable 111 fastens the further charging cable 101a to the further first suspension point 112a. In other words, the further charging cable 101a hangs down from the further boom 106a by way of the further carrier cable 111a. The further first carrier cable 111a may be fastened for example reversibly or irreversibly to the further charging cable 101a at the further first suspension point 112a. In a corresponding manner, the further second cable pull device 120a is fastened, reversibly or irreversibly, to the further charging cable 101a at the further second suspension point 122a by way of the further second carrier cable 121a, in such a way that the further charging cable 101a is suspended from the further boom 106a by way of the further second carrier cable 121a.

Each of the further carrier cables 111a, 121a can individually set the distance between the corresponding further suspension point 112a, 122a and the carrier structure 103a. In the case of an arrangement with two further cable pull devices 110a, 120a, the further charging cable 101a first of all extends from a further coupling point 116a on the carrier structure 103a, always for example on the crossbeam 104 or the further beam 106a, to the further first cable pull device 110a, or to a coupling at the further first suspension point 112a. From there, the further charging cable 101a extends to the further second cable pull device 120a, or to the further second suspension point 122a on the further second carrier cable 121a. From the further second suspension point 122a, the further charging cable 101a extends onward as far as its end, at which the further charging plug 102a is disposed.

The further first cable pull device 110a and the further second cable pull device 120a each have a cable winch 109a. The cable winch 109a is similar to the cable winch 109 described with respect to FIG. 1. In particular it is a driven cable winch which can wind up and unwind the corresponding carrier cable 111a, 121a.

It should additionally be noted that “comprising” does not exclude other elements or steps and “a,” “an” or “one” does not exclude a plurality. It should also be noted that features or steps which have been described with reference to one of the above exemplary embodiments can also be used in combination with other features or steps of other above-described exemplary embodiments. Reference signs in the claims should not be considered restrictive.

The following is a summary list of reference numerals and the corresponding structure used in the above description of the invention:
100, 100a Device
101, 101a Charging cable
102, 102a Charging plug
103, 103a Carrier structure
104 Crossbeam
105 Ground support
106, 106a Boom
107, 107a Reinforcement beam
108, 108a Reinforcement cable
109, 109a Cable winch
110, 110a First cable pull device
111, 111a First carrier cable
112, 112a First suspension point
113 Operating element
114 Charge distributor
115 Ground
116, 116a Coupling point
120, 120a Second cable pull device
121, 121a Second carrier cable
122, 122a Second suspension point
150, 150a Vehicle
201 Handling cable
301 Ceiling construction
302 Cable winch at the suspension point
401 Third cable pull device
402 Third carrier cable
403 Third suspension point
h Horizontal direction component

1. A device for providing a charging cable for a vehicle, the device comprising:
a carrier structure configured to be fastened at a distance from the ground;
a charging cable configured to be connected to an electricity source, said charging cable being fastened to said carrier structure, said charging cable having a charging plug for plugging into a vehicle to be charged, and said charging cable having first and second suspension points disposed at a distance from one another;
a first cable pull device fastened to said carrier structure, said first cable pull device having a first carrier cable fastened between said first suspension point and said carrier structure; and
a second cable pull device fastened to said carrier structure at a distance from said first cable pull device, said second cable pull device having a second carrier cable fastened between said second suspension point and said carrier structure;
said first cable pull device and said second cable pull device independently setting lengths of said first carrier cable and said second carrier cable, permitting distances from said first suspension point and from said second suspension point to the ground to be set.

2. The device according to claim 1, which further comprises:
a coupling point coupling said charging cable to said carrier structure;
said charging cable extending from said coupling point to said first suspension point and then onward to said second suspension point;
said charging cable being disposed on said carrier structure, said first cable pull device and said second cable pull device; and
said coupling point being located between said first suspension point and said second suspension point along a horizontal direction component.

3. The device according to claim 1, wherein:
said carrier structure has a crossbeam on which said first cable pull device and said second cable pull device are disposed; and
a ground support is configured to fasten at least one side of said crossbeam at a distance from the ground, or
said crossbeam is configured to be fastened to a ceiling construction or to a ceiling of a building.

4. The device according to claim 3, wherein:
said carrier structure has a boom on which at least one of said first cable pull device or said second cable pull device is disposed; and
said boom is fastened to said crossbeam and projects laterally relative to an extension direction of said crossbeam.

5. The device according to claim 4, wherein said boom is configured to be fastened pivotably to said crossbeam.

6. The device according to claim 4, wherein said boom is movable in the extension direction of said crossbeam.

7. The device according to claim 4, wherein:
said boom has two ends and a reinforcement beam protruding from said boom between said two boom ends; and
at least one tensioned reinforcement cable interconnects said boom ends and said reinforcement beam to stabilize said boom.

8. The device according to claim 1, wherein at least one of said first cable pull device or said second cable pull device has a cable winch.

9. The device according to claim 8, wherein said cable winch is an electric cable winch for setting a length of a corresponding one of said carrier cables.

10. The device according to claim 9, which further comprises:
an operating element for controlling said electric cable winch, said operating element being disposed in said charging cable or on said charging plug; and
said operating element is coupled to said electric cable winch wirelessly or by wire, for an exchange of control data.

11. The device according to claim 8, wherein said cable winch has a spring-based retraction device with a return spring or a spiral return spring for setting a length of a corresponding one of said carrier cables, and said retraction device is configured to generate a pretension in said return spring or said spiral return spring upon extending said corresponding one of said carrier cables out of said cable winch.

12. The device according to claim 8, wherein said cable winch is disposed on said carrier structure or at a corresponding one of said suspension points.

13. The device according to claim 1, which further comprises a handling cable fastened to said charging cable, said handling cable being disposed to permit said charging cable to be reached by a user by utilizing said handling cable.

14. The device according to claim 1, which further comprises a charge distributor disposed on said carrier structure and coupled to said charging cable.

15. The device according to claim 1, which further comprises:
a third cable pull device fastened to said carrier structure at a distance from said first cable pull device and from said second cable pull device;
said charging cable having a third suspension point disposed at a distance from said first suspension point and from said second suspension point;
said third cable pull device having a third carrier cable fastened between said third suspension point and said carrier structure; and
said third cable pull device permitting a length of said third carrier cable to be set.

16. The device according to claim 1, which further comprises:
a further charging cable configured to be connected to an electricity source, said further charging cable being fastened to said carrier structure, said further charging cable having a further charging plug for plugging into a further vehicle to be charged, and said further charging cable having further first and further second suspension points disposed at a distance from one another;
a further first cable pull device fastened to said carrier structure, said further first cable pull device having a further first carrier cable fastened between said further first suspension point and said carrier structure; and
a further second cable pull device fastened to said carrier structure at a distance from said further first cable pull device, said further second cable pull device having a further second carrier cable fastened between said further second suspension point and said carrier structure; and
said further first cable pull device and said further second cable pull device independently setting lengths of said further first carrier cable and said further second carrier cable, permitting distances from said further first suspension point and from said further second suspension point to the ground to be set.

17. A method for providing a charging cable for a vehicle, the method comprising:
providing a device according to claim 1; and
setting the lengths of said first carrier cable and of said second carrier cable independently of one another, to set the distance from said first suspension point and from said second suspension point to the ground.
